(19) United States
(12) Patent Application Publication
(10) Pub. No.: US 2008/0299434 A1
(43) Pub. Date: Dec. 4, 2008

(54) SOLID OXIDE TYPE FUEL CELL AND MANUFACTURING METHOD THEREOF

(75) Inventors: Fumimasa KATAGIRI, Nagano-shi (JP); Jun Yoshiike, Nagano-shi (JP); Yasue Tokutake, Nagano-shi (JP); Shigeaki Suganuma, Nagano-shi (JP); Michio Horiuchi, Nagano-shi (JP)

Correspondence Address: DRINKER BIDDLE & REATH (DC), 1500 K STREET, N.W., SUITE 1100, WASHINGTON, DC, 20005-1209, US

(73) Assignee: Shinko Electric Industries Co., Ltd., Nagano-shi (JP)

(21) Appl. No.: 12/127,974

(22) Filed: May 28, 2008

(30) Foreign Application Priority Data
May 29, 2007 (JP) 2007-142173

(51) Int. Cl. H01M 8/10; B05D 5/12; B32B 37/00

(52) U.S. Cl. 429/30; 427/115; 156/60

(57) ABSTRACT

A solid oxide type fuel cell has a solid electrolyte substrate with a flat plate shape, and a cathode electrode layer is formed in a flat plate shape on one surface of the substrate and an anode electrode layer is formed in a flat plate shape on the other surface. The cathode electrode layer and the anode electrode layer are formed by the same electrode formation material. One or both of the cathode electrode layer and the anode electrode layer contain the electrode formation material and a solid electrolyte, and a concentration of the solid electrolyte included in the cathode electrode layer or the anode electrode layer increases with approach to the solid electrolyte substrate. Also, the solid oxide type fuel cell is formed by simultaneously calcining the solid electrolyte substrate, the cathode electrode layer and the anode electrode layer.

This application claims priority to Japanese Patent Application No. 2007-142173, filed May 29, 2007, in the Japanese Patent Office. The Japanese Patent Application No. 2007-142173 is incorporated by reference in its entirety.

### TECHNICAL FIELD

The present disclosure relates to a solid oxide type fuel cell and a manufacturing method thereof, and particularly to a solid oxide type fuel cell having a solid electrolyte substrate in which a cathode electrode layer and an anode electrode layer are formed, the fuel cell in which manufacture is easy and a manufacturing cost is reduced, and a manufacturing method thereof.

### RELATED ART

In recent years, fuel cells of various power generation forms have been developed and among these fuel cells, there is a solid oxide type fuel cell of a form using a solid electrolyte. One example of this solid oxide type fuel cell includes a fuel cell using a calcined body made of stabilized zirconia to which yttria (Y₂O₃) is added as a solid electrolyte layer of an oxygen ion conduction type. It is constructed so that a cathode electrode layer is formed on one surface of this solid electrolyte layer and an anode electrode layer is formed on a surface opposite to one surface and oxygen or oxygen-containing gas is supplied to the side of this cathode electrode layer and fuel gas such as methane is further supplied to the anode electrode layer.

Inside this solid oxide type fuel cell, oxygen (O₂) supplied to the cathode electrode layer is ionized to an oxygen ion (O₂⁻) by a reduction reaction at the boundary between the cathode electrode layer and the solid electrolyte layer and this oxygen ion is conducted to the anode electrode layer by the solid electrolyte layer and reacts with, for example, methane (CH₄) gas supplied to the anode electrode layer and therefore, water (H₂O), carbon dioxide (CO₂), hydrogen (H₂) and carbon monoxide (CO) are generated by an oxidation reaction. In this reaction, the oxygen ion emits an electron, so that a potential difference is generated between the cathode electrode layer and the anode electrode layer. Therefore, when a lead wire is attached to the cathode electrode layer and the anode electrode layer, an electron of the anode electrode layer flows to the side of the cathode electrode layer through the lead wire and results in power generation as the solid oxide type fuel cell. In addition, a driving temperature of this solid oxide type fuel cell is about 1000° C.

However, in a power generation apparatus by the solid oxide type fuel cell of this form, a separate type chamber in which an oxygen or oxygen-containing gas supply chamber and a fuel gas supply chamber are respectively separated in the cathode electrode layer side and the anode electrode layer side must be prepared and it was necessary to receive the solid oxide type fuel cell in a container of a sealed structure.

Therefore, a solid oxide type fuel cell of an opened type in which it is unnecessary to receive the solid oxide type fuel cell in the container of the sealed structure has been proposed (for example, Patent Reference 1). In the solid oxide type fuel cell described in Patent Reference 1, a form in which flames are directly used in fuel supply to the solid oxide type fuel cell is disclosed. As a result of that, in this solid oxide type fuel cell, electromotive time can be shortened and the structure is simple, so that it is advantageous in cost cutting, reduction in size and weight of a power generation apparatus of the solid oxide type fuel cell. Then, in the respect that flames are directly used, the fuel cell can be incorporated into general combustor, incinerator, etc., and is expected to be used as an electric power supply apparatus.

[Patent Reference 1] Japanese Patent Application Publication No. 2004-139936

By the way, the related-art solid oxide type fuel cell as described in Patent Reference 1 is manufactured through calcination steps of two times or more as shown in FIGS. 11A to 11D.

An example of a manufacturing method of this related-art solid oxide type fuel cell will hereinafter be described with reference to FIGS. 11A to 11D.

First, a solid electrolyte paste made of a formation material of a solid electrolyte substrate is applied to a flat plate and the solid electrolyte paste is dried and thereafter is peeled from the flat plate and calcination of the first time is performed and a solid electrolyte substrate 1 shown in FIG. 11A is produced.

Next, as shown in FIGS. 11B and 11C, a cathode electrode material paste made of a formation material of a cathode electrode layer is printed on one surface of the solid electrolyte substrate 1 and also an anode electrode material paste made of a formation material of an anode electrode layer is printed on the other surface of the solid electrolyte substrate 1 and both the pastes are dried and thereafter calcination of the second time is performed and thereby, a cathode electrode layer 2 and an anode electrode layer 3 are formed and a solid oxide type fuel cell 10 shown in FIG. 11D is obtained.

Here, as shown in FIG. 11B, after the cathode electrode material paste is printed on one surface of the solid electrolyte substrate 1 and is once calcined, the anode electrode material paste may be printed on the other surface of the solid electrolyte substrate 1. In this case, calcinations of the sum of three times are performed in order to obtain the solid oxide type fuel cell 10 shown in FIG. 11D.

Thus, the calcination steps of at least two times were required in the manufacturing step of the related-art solid oxide type fuel cell.

On the other hand, an attempt to decrease the number of calcinations and manufacture the solid oxide type fuel cell by calcination of one time was also produced.

That is, first, a solid electrolyte paste made of a formation material of a solid electrolyte substrate is applied to a flat plate and this solid electrolyte paste is dried and thereafter is peeled from the flat plate and a solid electrolyte sheet 100 is produced as shown in FIG. 12A.

Next, a cathode electrode material paste is printed on one surface of the solid electrolyte sheet 100 as shown in FIG. 12B and then, an anode electrode material paste is printed on the other surface of the solid electrolyte sheet as shown in FIG. 12C.

Then, both the electrode material pastes are dried and a sheet laminated body 400 in which a cathode electrode material sheet 200 and an anode electrode material sheet 300 are formed on both surfaces of the solid electrolyte sheet 100 is produced as shown in FIG. 12D.

Thereafter, calcination of the sheet laminated body 400 is performed one time and a solid oxide type fuel cell 10 shown in FIG. 12E is obtained.

However, in the solid oxide type fuel cell manufactured by calcination of one time by simultaneously calcining the solid electrolyte, the cathode electrode material and the anode electrode material thus, for example, a crack or a swell occurs in the whole solid oxide type fuel cell 10 so that the solid electrolyte substrate 1 curves convexly toward the side of a cathode electrode layer 2 as shown in FIG. 12E.

Then, when the solid oxide type fuel cell has the swell etc. and is not flat, the solid oxide type fuel cell cannot be disposed in a solid oxide type fuel cell power generation apparatus whose dimension is determined. Also, when the solid oxide type fuel cell has the crack, power generation characteristics of the fuel cell decrease.

The reason why the crack or the swell occurs when the solid oxide type fuel cell is manufactured by calcination of one time as described above is as follows.

The cathode electrode layer 2 or an anode electrode layer 3 of the related-art solid oxide type fuel cell 10 is formed by different electrode formation materials in order to undergo an oxidation reaction or a reduction reaction of a fuel component or an oxidizing agent component. As a result of that, in the cathode electrode layer or the anode electrode layer 3, thermal characteristics such as respective thermal expansion coefficients vary, so that when the electrode layers are calcined by high-temperature treatment of a calcination step, a swell occurs in the whole solid oxide type fuel cell 10 so that the solid electrolyte substrate 1 curves convexly toward the side of the cathode electrode layer 2 as shown in FIG. 12E, for example, when a shrinkage factor σa by sintering of the anode electrode layer 3 is larger than a shrinkage factor σc by sintering of the cathode electrode layer 2 as shown in FIG. 13. Also, in some cases, a crack occurs in the solid oxide type fuel cell 10.

In order to avoid such trouble, in manufacture of the related-art solid oxide type fuel cell, it was necessary to previously calcine the solid electrolyte substrate 1 and improve stiffness so that the solid electrolyte substrate 1 located in the center can receive internal stress of the cathode electrode layer 2 or the anode electrode layer 3. Thereafter, as shown in the example of FIG. 11B or FIG. 11C, the cathode electrode layer 2 or the anode electrode layer 3 is calcined, so that calcination steps of two times or more were required.

### SUMMARY

Exemplary embodiments of the present invention provide a solid oxide type fuel cell in which manufacture is easy and a manufacturing cost is reduced, and a manufacturing method of the solid oxide type fuel cell.

A solid oxide type fuel cell of the invention has a solid electrolyte substrate and a cathode electrode layer is formed on one surface of the substrate and an anode electrode layer is formed on the other surface and the cathode electrode layer and the anode electrode layer are formed by the same electrode formation material.

Also, in the invention, the electrode formation material is preferably made of one or plural oxides selected from ferrite, manganate and cobaltate.

Also, in the invention, at least one of the cathode electrode layer or the anode electrode layer contains the electrode formation material and a solid electrolyte, and a concentration of the solid electrolyte included in the cathode electrode layer or the anode electrode layer preferably increases with approach to the solid electrolyte substrate.

Also, in the invention, the cathode electrode layer or the anode electrode layer preferably has a multilayer structure by layers having different solid electrolyte concentrations.

Also, in the invention, at least one of the cathode electrode layer or the anode electrode layer is formed in a porous state, and a porosity in the cathode electrode layer or the anode electrode layer preferably increases with distance from the solid electrolyte substrate.

Also, in the invention, the cathode electrode layer or the anode electrode layer preferably has a multilayer structure by layers having different porosities.

Also, in the invention, one or plural oxidation catalysts selected from rhodium oxide, ruthenium oxide and titanium oxide are preferably added to the anode electrode layer.

Also, the solid oxide type fuel cell of the invention is preferably placed in premixed fuel in which a fuel component is mixed with an oxidizing agent component.

Also, in the solid oxide type fuel cell of the invention, the anode electrode layer is exposed to flames by combustion of a fuel component and air is preferably supplied to the cathode electrode layer.

Also, in a manufacturing method of a solid oxide type fuel cell of the invention, having a solid electrolyte substrate, the solid oxide type fuel cell in which a cathode electrode layer is formed on one surface of the substrate and an anode electrode layer is formed on the other surface, a solid electrolyte sheet made of a formation material of the solid electrolyte substrate is produced, and electrode material pastes made of electrode formation materials are respectively applied to both surfaces of the solid electrolyte sheet, and the electrode material pastes are dried and a sheet laminated body in which a cathode electrode material sheet and an anode electrode material sheet are laminated on both surfaces of the solid electrolyte sheet is produced, and the sheet laminated body is calcined and the solid oxide type fuel cell is formed.

Further, in a manufacturing method of a solid oxide type fuel cell of the invention, having a solid electrolyte substrate, the solid oxide type fuel cell in which a cathode electrode layer is formed on one surface of the substrate and an anode electrode layer is formed on the other surface, a solid electrolyte sheet made of a formation material of the solid electrolyte substrate is produced, and a sheet laminated body is produced by placing a cathode electrode material sheet made of a formation material of the cathode electrode layer on one surface of the solid electrolyte sheet and placing an anode electrode material sheet made of the same electrode formation material as the formation material of the cathode electrode layer on the other surface of the solid electrolyte sheet, and the sheet laminated body is calcined and the solid oxide type fuel cell is formed.

According to a solid oxide type fuel cell of the invention and a manufacturing method thereof as described above, manufacture of the solid oxide type fuel cell is easy and the manufacturing cost is reduced.

Other features and advantages may be apparent from the following detailed description, the accompanying drawings and the claims.

### BRIEF DESCRIPTION OF THE DRAWINGS

FIG. 1A is a plan view showing a first embodiment of a solid oxide type fuel cell of the invention.

FIG. 1B is a sectional view taken on line X-X of FIG. 1A.

FIG. 2 is a view showing a situation in which electric power is generated by directly exposing the solid oxide type fuel cell of FIG. 1A to flames.

FIG. 3 is a view showing a second embodiment of a solid oxide type fuel cell of the invention.

FIG. 4 is a view showing a third embodiment of a solid oxide type fuel cell of the invention.

FIGS. 5A to 5E are views showing a first aspect of a manufacturing method of a solid oxide type fuel cell of the invention.

FIG. 6 is a view showing a situation in which the solid oxide type fuel cell of FIG. 5E shrinks by calcination.

FIGS. 7A to 7C are views showing a second aspect of a manufacturing method of a solid oxide type fuel cell of the invention.

FIG. 8 is a view showing power generation output characteristics of Examples.

FIG. 9 is a view showing power generation output characteristics of Examples of the case where a hole formation material is added to a cathode electrode layer and the case where a hole formation material is not added to a cathode electrode layer.

FIG. 10 is a view showing power generation output characteristics of Examples of the case where an oxidation catalyst is added to an anode electrode layer and the case where an oxidation catalyst is not added to an anode electrode layer.

FIGS. 11A to 11D are views showing an example of a manufacturing method of a solid oxide type fuel cell according to a related art.

FIGS. 12A to 12E are views showing another example of a manufacturing method of a solid oxide type fuel cell according to a related art.

FIG. 13 is a view showing a situation in which the solid oxide type fuel cell of FIG. 12E shrinks by calcination.

### DETAILED DESCRIPTION

A solid oxide type fuel cell 10 of the invention will hereinafter be described with reference to the drawings based on its preferred first embodiment.

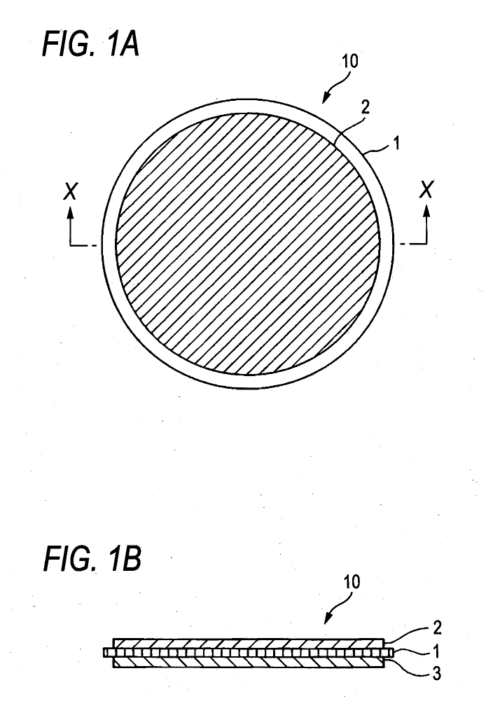

As shown in FIGS. 1A and 1B, the solid oxide type fuel cell 10 of the present embodiment has a solid electrolyte substrate 1 with a flat plate shape, and a cathode electrode layer 2 is formed in a flat plate shape on one surface of the substrate, and an anode electrode layer 3 is formed in a flat plate shape on the other surface, and the cathode electrode layer 2 and the anode electrode layer 3 are formed by the same electrode formation material.

The solid oxide type fuel cell 10 has the flat plate shape as a whole. A shape in plan view of the solid oxide type fuel cell 10 can be formed in any shape as usage. In the embodiment, the shape is a circular shape and each of the solid electrolyte substrate 1, the cathode electrode layer 2 and the anode electrode layer 3 has the circular shape. Dimensions of the cathode electrode layer 2 and the anode electrode layer 3 are equal and are formed somewhat smaller than that of the solid electrolyte substrate 1.

Then, it is preferable to properly design a dimension of the solid oxide type fuel cell 10 according to power generation characteristics required.

At the time of power generation, the solid electrolyte substrate 1 of the solid oxide type fuel cell 10 does not substantially have electron conductivity and transmits an ion such as an oxygen ion. Also, at the time of power generation, the cathode electrode layer 2 is exposed to an oxidizing atmosphere of an oxidizing agent component etc. and has catalytic action of giving an electron to oxygen which is, for example, an oxidizing agent and causing a reduction reaction. Further, at the time of power generation, the anode electrode layer 3 is exposed to a reducing atmosphere of a fuel component etc. and has catalytic action of causing an oxidation reaction with respect to hydrogen which is, for example, the fuel component.

In the solid oxide type fuel cell 10 of the embodiment, the cathode electrode layer 2 and the anode electrode layer 3 are formed by the same electrode formation material. This electrode formation material takes charge of a reduction reaction of the oxidizing agent component in the cathode electrode layer. Also, this electrode formation material takes charge of an oxidation reaction of the fuel component in the anode electrode layer.

Though detailed description is made below, the solid oxide type fuel cell 10 of the embodiment is preferably formed by simultaneously calcining the solid electrolyte substrate 1, the cathode electrode layer 2 and the anode electrode layer 3. In the solid oxide type fuel cell 10 of the embodiment, a flat shape without a swell or a crack can be produced by only performing calcination one time, so that its manufacture is easy.

Also, it is preferable that one or both of the cathode electrode layer 2 and the anode electrode layer 3 contain an electrode formation material and a solid electrolyte from the standpoint of improving properties of bonding to the solid electrolyte substrate 1 and approximating thermal characteristics such as a thermal expansion coefficient to the solid electrolyte substrate 1.

A kind of solid electrolyte included in the cathode electrode layer 2 or the anode electrode layer 3 may differ from a kind of solid electrolyte forming the solid electrolyte substrate 1, but it is particularly preferable that the kind be equal to the kind from the above standpoint.

Also, by including the solid electrolyte in each of the cathode electrode layer 2 or the anode electrode layer 3 thus, a chemical reaction field of a reduction reaction or an oxidation reaction increases, so that power generation characteristics are improved.

A concentration of the solid electrolyte in the cathode electrode layer 2 or the anode electrode layer 3 may be constant, but the concentration of the solid electrolyte preferably increases with approach to the solid electrolyte substrate 1 for the following reason.

By increasing the concentration of the solid electrolyte toward the side of the solid electrolyte substrate 1 in the cathode electrode layer 2 or the anode electrode layer 3, a bonding strength increases at the interface of the solid electrolyte substrate 1 by sintering of the mutual solid electrolytes and also thermal characteristics between the solid electrolyte substrate 1 and both the electrode layers 2, 3 approximate. As a result of that, joint properties and adhesion properties between the solid electrolyte substrate 1 and the cathode electrode layer 2 or the anode electrode layer 3 improve. A change in the concentration of this solid electrolyte may be continuous or stepwise. On the other hand, an oxidation reaction or a reduction reaction can be improved by decreasing the concentration of the solid electrolyte with distance from the solid electrolyte substrate 1 in the cathode electrode layer 2 or the anode electrode layer 3.

Next, formation materials of the solid oxide type fuel cell 10 will hereinafter be described.

In formation materials of the solid electrolyte substrate 1, for example, publicly known materials can be adopted and the following materials can be used.

a) YSZ (yttria-stabilized zirconia), ScSZ (scandia-stabilized zirconia), zirconia ceramics in which the YSZ or ScSZ is doped with Ce, Al, etc.
b) Ceria ceramics of SDC (samaria-doped ceria), SGC (gadolinia-doped ceria), etc.
c) LSGM (lanthanum gallate ceramics), bismuth oxide ceramics

In the present specification thus, the solid oxide has a concept including the solid electrolyte.

Then, formation materials of the cathode electrode layer 2 and the anode electrode layer 3 will hereinafter be described.

An electrode formation material of the cathode electrode layer 2 and the anode electrode layer 3 is preferably made of one or plural oxides selected from ferrite, manganate and cobaltate.

Lanthanum strontium ferrite (La_{0.6}Sr_{0.4}FeO₃: LSF) or lanthanum strontium cobalt ferrite (La_{0.6}Sr_{0.4}Co_{0.2}Fe_{0.8}O₃: LSCF) can preferably be used as ferrite.

Lanthanum strontium manganate (La_{0.8}Sr_{0.2}MnO₃: LSM) can preferably be used as manganate.

Lanthanum strontium cobaltate (La_{0.8}Sr_{0.2}Co_{0.3}: LSC) can preferably be used as cobaltate.

Also, in the solid oxide type fuel cell 10 of the embodiment, the cathode electrode layer 2 is preferably formed in a porous state. By forming the cathode electrode layer 2 in a porous body, pores and a specific surface area of the cathode electrode layer 2 are increased and a chemical reaction field of an acid point etc. is increased and an oxidizing agent component passes through the pores and tends to access the chemical reaction field, so that a reduction reaction of the oxidizing agent component accelerates. Also, by forming the cathode electrode layer 2 in the porous body, thermal shock resistance of the cathode electrode layer 2 improves and a crack etc. are prevented from occurring due to a sudden change in temperature.

A porosity in the cathode electrode layer 2 preferably increases with distance from the solid electrolyte substrate 1 from the standpoint of maintaining thermal stability of the cathode electrode layer 2 and ensuring joint properties to the solid electrolyte substrate 1 while ensuring a chemical reaction field of the cathode electrode layer 2. A change in the porosity in the cathode electrode layer 2 may be continuous or stepwise.

Similarly, the anode electrode layer 3 is formed in a porous state and its porosity preferably increases with distance from the solid electrolyte substrate 1 from the same standpoint as the above.

The porosity in the cathode electrode layer 2 or the anode electrode layer 3 is preferably 10 to 70% by volume, particularly 20 to 40% by volume. The porosity is larger than 10% by volume and thereby, access to a chemical reaction field of an oxidizing agent component or a fuel component is more than enough and a balance between conductivity of an ion and an electron improves. On the other hand, when the porosity is larger than 70% by volume, stiffness of the cathode electrode layer 2 or the anode electrode layer 3 decreases and a mechanical strength is insufficient.

Also, in the solid oxide type fuel cell 10 of the embodiment, a mesh-shaped metal or a wire-shaped metal may be buried or fixed in the cathode electrode layer 2 or the anode electrode layer 3. By using such a configuration, the solid oxide type fuel cell 10 cracked due to a heat history etc. is reinforced so as not to crumble to pieces and further, the cracked portion can be electrically connected in the mesh-shaped metal or the wire-shaped metal, so that durability of the solid oxide type fuel cell 10 can be improved.

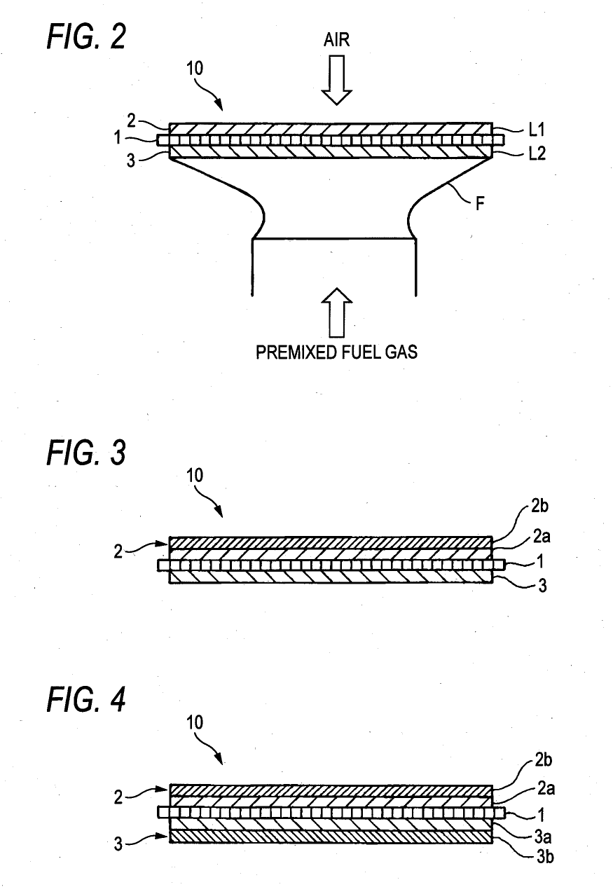

For example, as shown in FIG. 2, electric power can be generated by disposing the solid oxide type fuel cell 10 of the embodiment described above in flames F or in the vicinity of the flames F in a state of directing the anode electrode layer 3 to the side of the flames F. The flames F are preferably generated by combusting premixed fuel gas in which a fuel component is mixed with an oxidizing agent component.

In the solid oxide type fuel cell 10, the anode electrode layer 3 is exposed to the flames F by combustion of the premixed fuel gas under opening of atmospheric pressure and hydrocarbon, hydrogen, radicals (OH, CH, C₂, O₂H, CH₃), etc. present in the flames F are made easy to use as the fuel component. On the other hand, air is supplied to the cathode electrode layer 2.

The electric power generated by the solid oxide type fuel cell 10 is taken out by lead wires L1, L2 respectively led out of the cathode electrode layer 2 and the anode electrode layer 3. A lead wire made of thermally-resistant platinum or an alloy including platinum is used as the lead wire.

Also, the solid oxide type fuel cell 10 of the embodiment may be disposed inside a single type chamber to generate electric power in a state of being placed in premixed fuel in which a fuel component is mixed with an oxidizing agent component.

According to the solid oxide type fuel cell 10 of the embodiment described above, the cathode electrode layer 2 and the anode electrode layer 3 are formed by the same electrode formation material, so that the manufacture is easy and a manufacturing cost is reduced from the standpoint of adjustment and procurement of raw materials with a small kind. Particularly, by simultaneously calcining and forming the solid electrolyte substrate 1, the cathode electrode layer 2 and the anode electrode layer 3, the manufacturing cost can be reduced greatly. Also, even when both the electrode layers 2, 3 are formed after the solid electrolyte substrate 1 is calcined one time in the manufacture of the solid oxide type fuel cell 10, stresses applied to the solid electrolyte substrate 1 by thermal shrinkage by sintering of both the electrode layers 2, 3 are symmetrical, so that durability as the solid oxide type fuel cell 10 improves.

Also, by including the solid electrolyte in the cathode electrode layer 2 and the anode electrode layer 3, properties of bonding between the solid electrolyte substrate 1 and the cathode electrode layer 2 and the anode electrode layer 3 are improved and thermal characteristics can be approximated. As a result of that, occurrence of a swell or a crack is surely prevented even when the solid electrolyte substrate 1, the cathode electrode layer 2 and the anode electrode layer 3 are simultaneously calcined.

Further, the cathode electrode layer 2 and the anode electrode layer 3 are formed in the porous state, so that power generation characteristics and durability can be improved.

Next, a solid oxide type fuel cell of another embodiment of the invention will hereinafter be described with reference to FIGS. 3 and 4. The detailed description made in the first embodiment mentioned above is properly applied to the respect which is not particularly described in another embodiment. Also, in FIGS. 3 and 4, the same numerals are assigned to the same components as those of FIGS. 1A to 2.

In a solid oxide type fuel cell 10 of a second embodiment of the invention, a cathode electrode layer 2 has a multilayer structure by layers having different porosities as shown in FIG. 3. Concretely, the cathode electrode layer 2 has a two-layer structure in which a first cathode electrode layer 2a located in the side of a solid electrolyte substrate 1 and a second cathode electrode layer 2b located in the outside are laminated.

The second cathode electrode layer 2b is formed in a porous state by adding a hole formation material. On the other hand, the hole formation material is not added to the first cathode electrode layer 2a.

Therefore, in the solid oxide type fuel cell 10 of the present embodiment, a porosity of the cathode electrode layer 2 stepwise increases with distance from the solid electrolyte substrate 1.

Also, in the cathode electrode layer 2, a concentration of a solid electrolyte in the first cathode electrode layer 2a is higher than that of the second cathode electrode layer 2b, and the cathode electrode layer 2 has a multilayer structure by layers having different solid electrolyte concentrations. That is, the concentration of the solid electrolyte in the cathode electrode layer 2 stepwise increases with approach to the solid electrolyte substrate 1.

The other configurations are similar to those of the first embodiment described above.

According to the solid oxide type fuel cell 10 of the embodiment described above, since the second cathode electrode layer 2b located in the outside of the cathode electrode layer 2 is formed in the porous state, an oxidizing agent component tends to access the inside of the cathode electrode layer 2 and a chemical reaction field increases, so that power generation characteristics can be improved.

Also, the cathode electrode layer 2 is formed in the multilayer structure and the porosity and the concentration of the solid electrolyte are adjusted every layer, so that it is easy to produce the cathode electrode layer 2 in which the porosity and the concentration of the solid electrolyte are adjusted.

In a solid oxide type fuel cell 10 of a third embodiment of the invention, an anode electrode layer 3 has a multilayer structure as shown in FIG. 4. Concretely, the anode electrode layer 3 has a two-layer structure in which a first anode electrode layer 3a located in the side of a solid electrolyte substrate 1 and a second anode electrode layer 3b located in the outside are laminated.

Then, a catalyst other than an electrode formation material is added to the second anode electrode layer 3b. Concretely, an oxidation catalyst is added to the second anode electrode layer 3b.

During power generation, soot may be generated in the anode electrode layer 3 by a reaction of a fuel component. Then, when the soot is generated in the anode electrode layer 3, a pore is closed or a chemical reaction field of an acid point etc. is covered and power generation performance is decreased.

In the solid oxide type fuel cell 10 of the present embodiment, one or plural oxidation catalysts selected from rhodium oxide (Rh₂O₃), ruthenium oxide (RuO) and titanium oxide (TiO₂) are added to the second anode electrode layer 3b and generation of the soot described above is prevented.

It is preferable to be 1 to 10% by mass, particularly 1 to 5% by mass as a ratio of the oxidation catalyst added to the anode electrode layer 3.

When the ratio of the oxidation catalyst in the anode electrode layer 3 is smaller than 1% by mass, generation of the soot cannot be suppressed sufficiently. On the other hand, when the ratio of the oxidation catalyst in the anode electrode layer 3 is larger than 1% by mass, sufficient capability of suppressing generation of the soot is exercised.

Also, in the anode electrode layer 3, a concentration of a solid electrolyte in the first anode electrode layer 3a is higher than that of the second anode electrode layer 3b, and the anode electrode layer 3 has a multilayer structure by layers having different solid electrolyte concentrations. That is, the concentration of the solid electrolyte in the anode electrode layer 3 stepwise increases with approach to the solid electrolyte substrate 1.

Also, a cathode electrode layer 2 of the solid oxide type fuel cell 10 of the embodiment has a two-layer structure similar to that of the second embodiment described above. The other configurations are similar to those of the first embodiment described above.

According to the solid oxide type fuel cell 10 of the embodiment described above, since the oxidation catalyst is added to the second anode electrode layer 3b located in the outside of the anode electrode layer 3, generation of the soot in the anode electrode layer 3 is suppressed, so that durability of the solid oxide type fuel cell 10 can be improved.

Also, the anode electrode layer 3 is formed in the multilayer structure and the oxidation catalyst and the concentration of the solid electrolyte are adjusted every layer, so that it is easy to produce the anode electrode layer 3 in which the oxidation catalyst and the concentration of the solid electrolyte are adjusted.

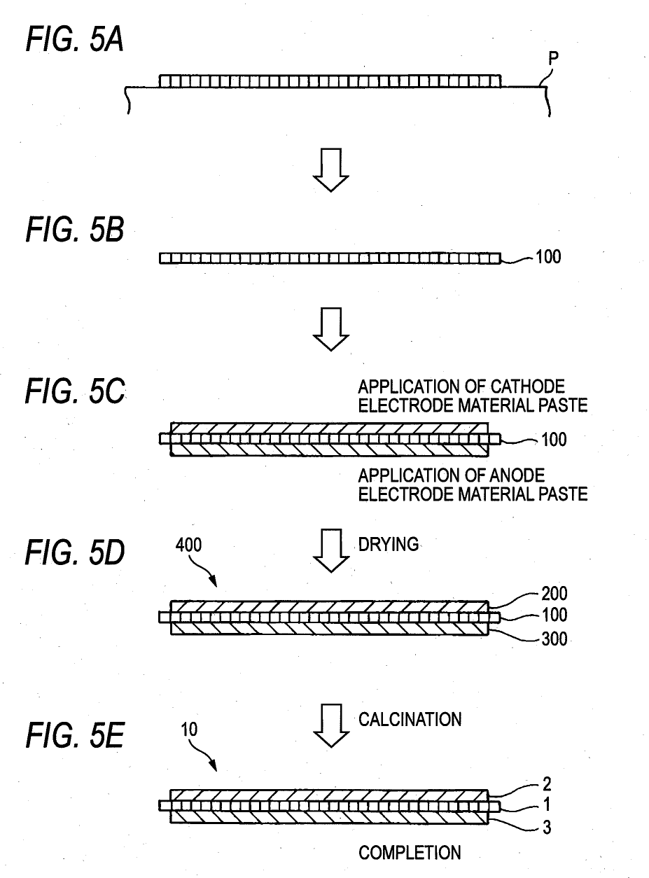

Next, an example of a manufacturing method of the solid oxide type fuel cell of the invention described above will hereinafter be described with reference to FIGS. 5A to 5E based on its preferred first aspect.

In the present aspect, a solid electrolyte paste made of a formation material of a solid electrolyte substrate is first applied to a surface of a flat plate P in a predetermined shape as shown in FIG. 5A. The solid electrolyte paste can be produced by mixing, for example, an organic solvent, a binder or powder of a solid electrolyte. Also, in application of the solid electrolyte paste, for example, a printing method such as a screen printing method can be used. As the predetermined shape, for example, a circular flat plate shape like the solid electrolyte substrate 1 shown in FIG. 1A can be given.

Also, a hole formation material may be added to the solid electrolyte paste in order to form the solid electrolyte substrate 1 in a porous state.

Next, after this solid electrolyte paste is dried, the dried solid electrolyte is peeled from the flat plate P and a solid electrolyte sheet 100 with a predetermined shape is produced as shown in FIG. 5B. Also, this solid electrolyte sheet 100 may be produced using a green sheet method.

Then, electrode material pastes made of the same electrode formation material are respectively applied to both surfaces of the solid electrolyte sheet 100 as shown in FIG. 5C. The electrode material paste can be produced by mixing, for example, an organic solvent, a binder or powder of the electrode formation material. Also, in application of this electrode material paste, the printing method such as the screen printing method described above can be used.

Also, an oxidation catalyst or a hole formation material may be added to the electrode material paste as necessary. The amount of addition of this hole formation material to the electrode material paste is preferably 50 to 70% by volume from the standpoint of improving electron and ion conductivity and diffusivity of premixed fuel gas etc. inside an electrode layer.

Then, the electrode material pastes are dried and a sheet laminated body 400 in which a cathode electrode material sheet 200 and an anode electrode material sheet 300 are laminated on both surfaces of the solid electrolyte sheet 100 is produced as shown in FIG. 5D.

Thereafter, the sheet laminated body 400 is calcined one time, and a solid oxide type fuel cell 10 having a solid electrolyte substrate 1 with a flat plate shape, the fuel cell 10 in which a cathode electrode layer 2 is formed in a flat plate shape on one surface of the substrate and an anode electrode layer 3 is formed in a flat plate shape on the other surface, is obtained as shown in FIG. 5E.

Here, a porosity in the solid electrolyte substrate 1, the cathode electrode layer 2 or the anode electrode layer 3 can be adjusted by adjusting calcination conditions such as calcination temperature, calcination time or preliminary calcination.

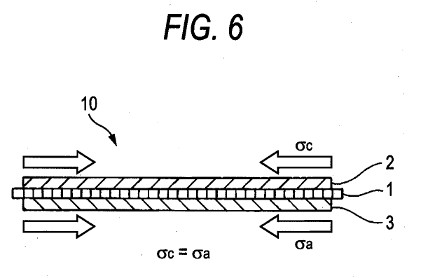

According to the aspect described above, the cathode electrode layer 2 and the anode electrode layer 3 of the solid oxide type fuel cell 10 are formed by the same electrode formation material, so that respective thermal characteristics of the cathode electrode layer 2 and the anode electrode layer 3 become equal. As a result of that, even when the sheet laminated body 400 is sintered by a calcination step, as shown in FIG. 6, a shrinkage factor σa by sintering of the anode electrode layer 3 becomes equal to a shrinkage factor ac by sintering of the cathode electrode layer 2 and the solid electrolyte substrate 1 does not curve and the whole is sintered in a state of the flat shape before calcination.

Therefore, by only simultaneously calcining the solid electrolyte substrate 1, the cathode electrode layer 2 and the anode electrode layer 3 one time, the flat solid oxide type fuel cell 10 without a swell or a crack can be manufactured, so that the manufacture is easy and the manufacturing cost can be reduced.

Also, the manufacturing cost can be reduced from the standpoint of adjustment and procurement of raw materials by using the same electrode formation material in the cathode electrode layer 2 and the anode electrode layer 3.

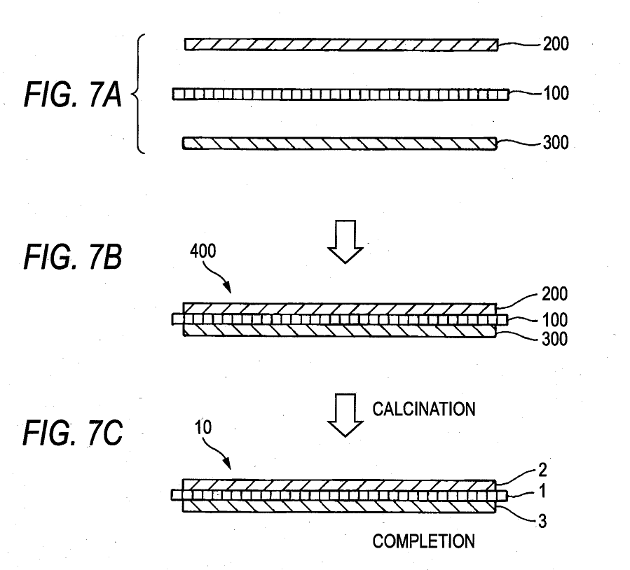

Next, a manufacturing method of the solid oxide type fuel cell of a second aspect of the invention described above will hereinafter be described with reference to FIGS. 7A to 7C. The detailed description made in the first aspect mentioned above is properly applied to the respect which is not particularly described in the second embodiment. Also, in FIGS. 7A to 7C, the same numerals are assigned to the same components as those of FIGS. 5A to 6.

In the present aspect, a solid electrolyte sheet 100 formed by drying a solid electrolyte paste made of a formation material of a solid electrolyte substrate 1 is first produced as shown in FIG. 7A. Also, a cathode electrode material sheet 200 formed by drying a cathode electrode material paste made of a formation material of a cathode electrode layer 2 is produced. Also, an anode electrode material sheet 300 formed by drying an anode electrode material paste made of the same electrode formation material as the formation material of the anode electrode layer 3 is produced.

The solid electrolyte sheet 100, the cathode electrode material sheet 200 or the anode electrode material sheet 300 can easily be produced by, for example, a green sheet method. Or, they may be produced in a manner similar to the solid electrolyte sheet of the first aspect described above. Here, the solid electrolyte sheet 100, the cathode electrode material sheet 200 or the anode electrode material sheet 300 are dried and are in a state before calcination.

Next, after the cathode electrode material sheet 200 is placed on one surface of the solid electrolyte sheet 100 and the anode electrode material sheet 300 is placed on the other surface of the solid electrolyte sheet 100, a sheet laminated body 400 is integrally produced by crimping as shown in FIG. 7B.

Thereafter, the sheet laminated body 400 is calcined one time, and a solid oxide type fuel cell 10 having a solid electrolyte substrate 1 with a flat plate shape, the fuel cell 10 in which the cathode electrode layer 2 is formed in a flat plate shape on one surface of the substrate and an anode electrode layer 3 is formed in a flat plate shape on the other surface, is obtained as shown in FIG. 7C.

According to the aspect described above, an effect similar to that of the first aspect can be obtained.

The solid oxide type fuel cell of the invention and the manufacturing method thereof are not limited to the embodiments or the aspects described above, and changes can properly be made as long as they do not depart from the gist of the invention.

For example, catalysts other than the electrode formation material may be added to the cathode electrode layer 2. As the catalysts, for example, a catalyst for accelerating a reduction reaction of an oxidizing agent component is preferable.

Also, in the present specification, the fact that the cathode electrode layer 2 and the anode electrode layer 3 are formed by the same electrode formation material means including the case of using exactly the same electrode formation material in both the electrode layers 2, 3, and the case where exactly the same electrode formation material is not used but a material in which an electrode material used in one electrode layer is somewhat changed is used in formation of the other electrode layer and thermal characteristics such as thermal expansion coefficients of both the electrode formation materials are equal and the solid oxide type fuel cell after calcination is substantially flat and does not have a crack.

Also, in the second embodiment or the third embodiment described above, the cathode electrode layer 2 or the anode electrode layer 3 may have a multilayer structure of two layers or more. Also, it is preferable to adjust a solid electrolyte concentration, a porosity, a catalyst concentration or a thickness in each of the layers so as to improve thermal stability and power generation characteristics of the solid oxide type fuel cell in the case of forming the electrode layer in the multilayer structure. For example, a porosity in the anode electrode layer 3 may increase with distance from the solid electrolyte substrate and the anode electrode layer 3 may have a multilayer structure by layers having different porosities.

Also, in the first embodiment described above, one solid oxide type fuel cell 10 has been used in power generation, but it may be used as a solid oxide type fuel cell unit in which plural solid oxide type fuel cells 10 are connected in series or in parallel. Also, solid oxide type fuel cell units formed by connecting plural solid oxide type fuel cells 10 in series may be connected in parallel and be used. Further, solid oxide type fuel cell units formed by connecting plural solid oxide type fuel cells 10 in parallel may be connected in series and be used.

Also, in the first aspect described above, the sheet laminated body 400 having an electrode material of a multilayer structure may be produced by further applying an electrode material paste to the cathode electrode material sheet 200 or the anode electrode material sheet 300 and drying the electrode material paste.

Similarly, in the second aspect described above, the sheet laminated body 400 having an electrode material sheet of a multilayer structure may be produced by laminating a cathode electrode material sheet or an anode electrode material sheet separately prepared on the cathode electrode material sheet 200 or the anode electrode material sheet.

Requirements in one embodiment or aspect described above can properly be replaced mutually between the embodiments or aspects.

### EXAMPLE

The invention will hereinafter be described further using examples. However, the scope of the invention is not limited to such examples.

### 1. Case of Solid Oxide Type Fuel Cell Using the Same Electrode Formation Material in Both Electrode Layers

### Example 1

First, a solid electrolyte sheet using samaria-doped ceria (Sm_{0.2}Ce_{0.8}O_{1.9}: SDC) as a solid electrolyte was produced and calcined and a solid electrolyte substrate was produced. A dimension of the solid electrolyte substrate was 15 mm in diameter and was 150 to 200 μm in thickness. Next, an electrode material paste A in which 30% by mass of SDC as the solid electrolyte was added to lanthanum strontium cobalt ferrite (La_{0.6}Sr_{0.4}Co_{0.2}Fe_{0.8}O₃: LSCF) as an electrode formation material was produced and this electrode material paste A was respectively applied to both surfaces of the solid electrolyte substrate and was dried and a sheet laminated body was produced and thereafter, this sheet laminated body was calcined at 1300° C. and a solid oxide type fuel cell shown in FIG. 1A was obtained and Example 1 was implemented.

### Example 2

Example 2 was implemented by obtaining a solid oxide type fuel cell in a manner similar to Example 1 except that lanthanum strontium ferrite (La_{0.6}Sr_{0.4}FeO₃: LSF) was used as an electrode formation material.

### Example 3

Example 3 was implemented by obtaining a solid oxide type fuel cell in a manner similar to Example 1 except that lanthanum strontium manganate (La_{0.8}Sr_{0.2}MnO₃: LSM) was used as an electrode formation material.

### Example 4

Example 4 was implemented by obtaining a solid oxide type fuel cell in a manner similar to Example 1 except that lanthanum strontium cobaltate (La_{0.8}Sr_{0.2}Co_{0.3}: LSC) was used as an electrode formation material.

Table 1 shows the electrode formation materials used in Examples 1 to 4.

TABLE 1

| | Example | Example | Example | Example | Example | Example | Example |
|---|---|---|---|---|---|---|---|
| | 1 | 2 | 3 | 4 | 5 | 6 | 7 |
| Electrode | LSCF | LSF | LSM | LSC | LSCF | LSF | LSC |
| formation | | | | | | | |
| material | | | | | | | |
| Hole | Absence | Absence | Absence | Absence | Presence | Presence | Presence |
| formation | | | | | | | |
| material | | | | | | | |
| Oxidation | Absence | Absence | Absence | Absence | Absence | Absence | Absence |
| catalyst | | | | | | | |

[With Power Generation]

Using the solid oxide type fuel cells of Examples 1 to 4, as shown in FIG. 2, an anode electrode layer was directly exposed to flames and power generation was evaluated. In premixed fuel gas, n-butane was used as a fuel component and air was used as an oxidizing agent component. A concentration of n-butane in the premixed fuel gas was 4% by volume. Also, a flow rate of the premixed fuel gas was adjusted to 600 sccm. In addition, sccm means that a flow rate per minute measured at 1 atmospheric pressure (atmospheric pressure, 1014 hPa) and 0° C. is represented by ml (10⁻³ liter).

As a result of that, in all the solid oxide type fuel cells of Examples 1 to 4, power generation was checked. That is, it was checked that the solid oxide type fuel cell in which an anode electrode layer and a cathode electrode layer made of the same electrode formation material were respectively formed on both surfaces of the solid electrolyte substrate generated electric power as a fuel cell

2. Case of Solid Oxide Type Fuel Cell in which Porosity is Controlled

### Example 5

First, a solid electrolyte sheet using samaria-doped ceria (Sm_{0.2}Ce_{0.8}O_{1.9}: SDC) as a solid electrolyte was produced and calcined and a solid electrolyte substrate was produced. A dimension of the solid electrolyte substrate was 15 mm in diameter and was 150 to 200 μm in thickness. Next, an electrode material paste A in which 30% by mass of SDC as the solid electrolyte was added to LSCF as an electrode formation material was produced and this electrode material paste A was applied to one surface of the solid electrolyte substrate and was dried.

Then, an electrode material paste B in which 50% by mass of SDC as the solid electrolyte was added to LSCF as an electrode formation material was produced and this electrode material paste B was applied to the other surface of the solid electrolyte substrate and was dried.

Then, an electrode material paste C in which 65% by volume of a hole formation material was added to LSCF as an electrode formation material was produced and this electrode material paste C was further applied to the dried electrode material paste B on the other surface of the solid electrolyte substrate and was dried and a sheet laminated body was produced and thereafter, this sheet laminated body was calcined at 1300° C. and a solid oxide type fuel cell shown in FIG. 3 was obtained and Example 5 was implemented. That is, the solid oxide type fuel cell having a cathode electrode layer of a two-layer structure was produced.

### Example 6

Example 6 was implemented by obtaining a solid oxide type fuel cell in a manner similar to Example 5 except that LSF was used as an electrode formation material.

### Example 7

Example 7 was implemented by obtaining a solid oxide type fuel cell in a manner similar to Example 5 except that LSC was used as an electrode formation material.

Table 1 shows the electrode formation materials used in Examples 5 to 7.

[With Power Generation Output Characteristics]

Using the solid oxide type fuel cells of Examples 5 to 7 and Example 1, power generation output characteristics were evaluated as shown in FIG. 2. In premixed fuel gas, n-butane was used as a fuel component and air was used as an oxidizing agent component. A concentration of n-butane in the premixed fuel gas was 4% by volume. Also, a flow rate of the premixed fuel gas was adjusted to 600 sccm.

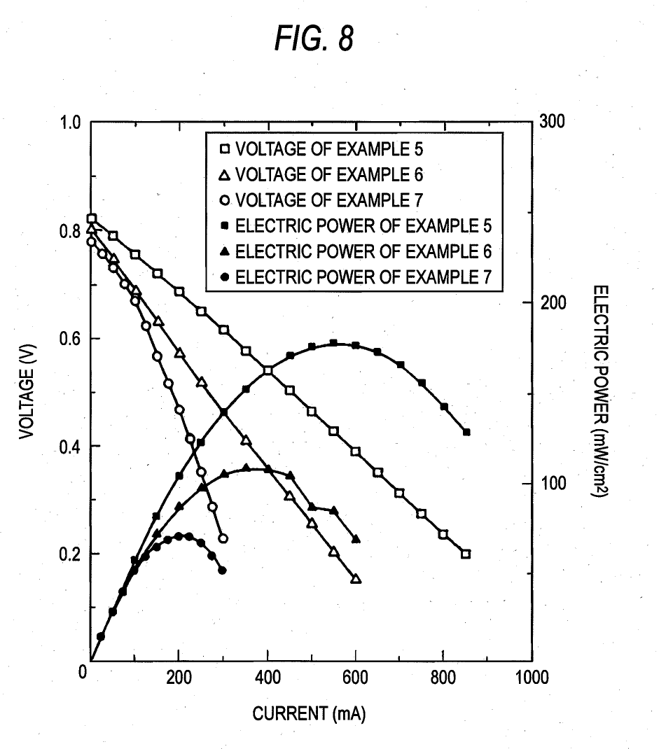

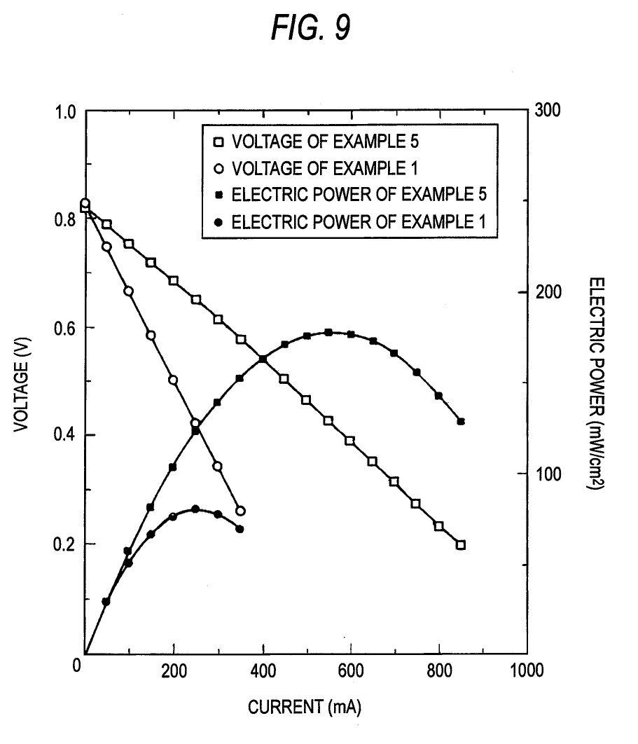

The results are shown in FIGS. 8 and 9. Concretely, voltage-current characteristics and electric power-current characteristics were measured.

It was apparent from FIG. 8 that the maximum electric powers respectively showed about 180 mW/cm², about 110 mW/cm² and about 70 mW/cm² in Examples 5 to 7 and power generation output characteristics equivalent to those of a related-art solid oxide type fuel cell were shown.

Also, it was apparent from FIG. 9 that Example 5 was better than Example 1 in power generation output characteristics and the power generation output characteristics could be improved by controlling a porosity of a cathode electrode layer.

3. Case of Solid Oxide Type Fuel Cell to which Oxidation Catalyst is Added

### Example 8

First, a solid electrolyte sheet using samaria-doped ceria (Sm_{0.2}Ce_{0.8}O_{1.9}: SDC) as a solid electrolyte was produced and calcined and a solid electrolyte substrate was produced. A dimension of the solid electrolyte substrate was 15 mm in diameter and was 150 to 200 μm in thickness. Next, an electrode material paste A in which 30% by mass of SDC as the solid electrolyte was added to LSCF as an electrode formation material was produced and this electrode material paste A was applied to one surface of the solid electrolyte substrate and was dried.

Then, an electrode material paste D in which 5% by mass of ruthenium oxide (RuO) as an oxidation catalyst was added to LSCF as an electrode formation material was produced and this electrode material paste D was further applied to the dried electrode material paste A on one surface of the solid electrolyte substrate and was dried.

Then, an electrode material paste B in which 50% by mass of SDC as the solid electrolyte was added to LSCF as an electrode formation material was produced and this electrode material paste B was applied to the other surface of the solid electrolyte substrate and was dried.

Then, an electrode material paste C in which 65% by volume of a hole formation material was added to LSCF as an electrode formation material was produced and this electrode material paste C was further applied to the dried electrode material paste B on the other surface of the solid electrolyte substrate and was dried and a sheet laminated body was produced and thereafter, this sheet laminated body was calcined at 1300° C. and a solid oxide type fuel cell shown in FIG. 4 was obtained and Example 8 was implemented. That is, the solid oxide type fuel cell having each of the cathode electrode layer and the anode electrode layer of a two-layer structure was produced. The oxidation catalyst is added to the anode electrode layer and the hole formation material is added to the cathode electrode layer.

### Example 9

Example 9 was implemented by obtaining a solid oxide type fuel cell in a manner similar to Example 8 except that titanium oxide (TiO₂) was used as an oxidation catalyst.

### Example 10

Example 10 was implemented by obtaining a solid oxide type fuel cell in a manner similar to Example 8 except that LSF was used as an electrode formation material.

### Example 11

Example 11 was implemented by obtaining a solid oxide type fuel cell in a manner similar to Example 8 except that LSM was used as an electrode formation material and rhodium oxide (Rh₂O₃) was used as an oxidation catalyst.

### Example 12

Example 12 was implemented by obtaining a solid oxide type fuel cell in a manner similar to Example 8 except that an oxidation catalyst was not added to a layer of the outside of an anode electrode layer.

### Example 13

Example 13 was implemented by obtaining a solid oxide type fuel cell in a manner similar to Example 10 except that an oxidation catalyst was not added to a layer of the outside of an anode electrode layer.

### Example 14

Example 14 was implemented by obtaining a solid oxide type fuel cell in a manner similar to Example 11 except that an oxidation catalyst was not added to a layer of the outside of an anode electrode layer.

Table 2 shows the presence or absence of the hole formation materials or the oxidation catalysts and the electrode formation materials used in Examples 8 to 14.

TABLE 2

| | Example | Example | Example | Example | Example | Example | Example |
|---|---|---|---|---|---|---|---|
| | 8 | 9 | 10 | 11 | 12 | 13 | 14 |
| Electrode | LSCF | LSCF | LSF | LSM | LSCF | LSF | LSM |
| formation | | | | | | | |
| material | | | | | | | |
| Hole | Presence | Presence | Presence | Presence | Presence | Presence | Presence |
| formation | | | | | | | |
| material | | | | | | | |
| Oxidation | RuO | TiO₂ | RuO | Rh₂O₃ | Absence | Absence | Absence |
| catalyst | | | | | | | |

[With Power Generation Output Characteristics]

Using the solid oxide type fuel cells of Examples 8 to 14, the power generation output characteristics described above were evaluated and values of the maximum electric powers were examined.

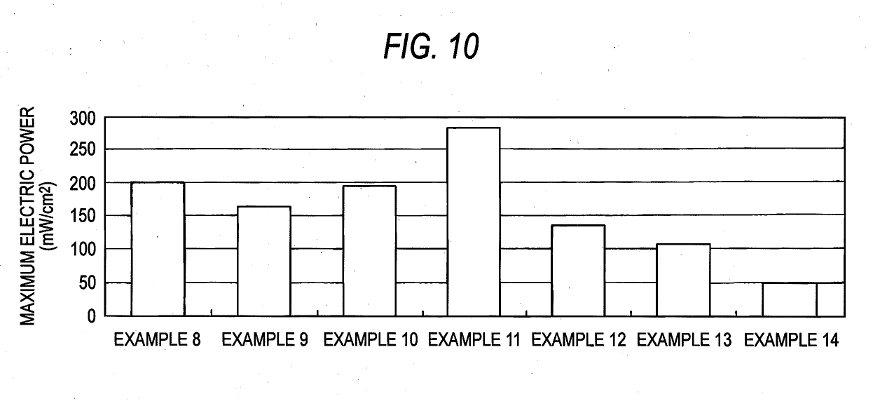

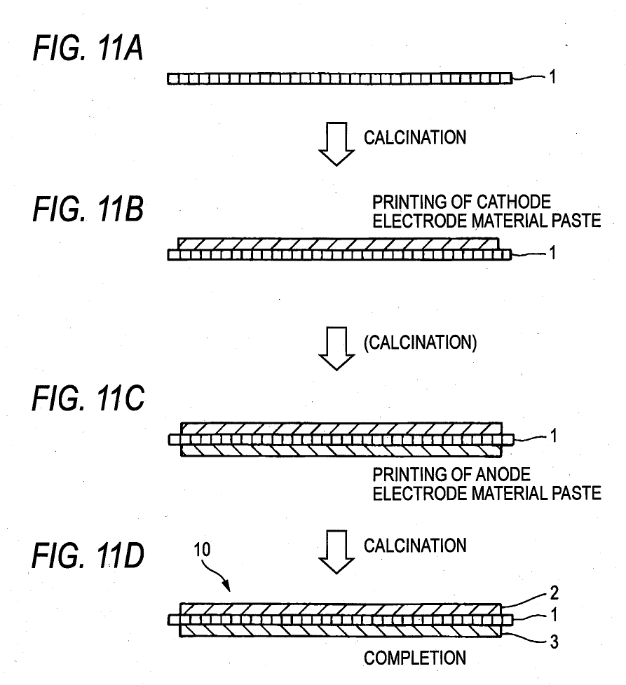

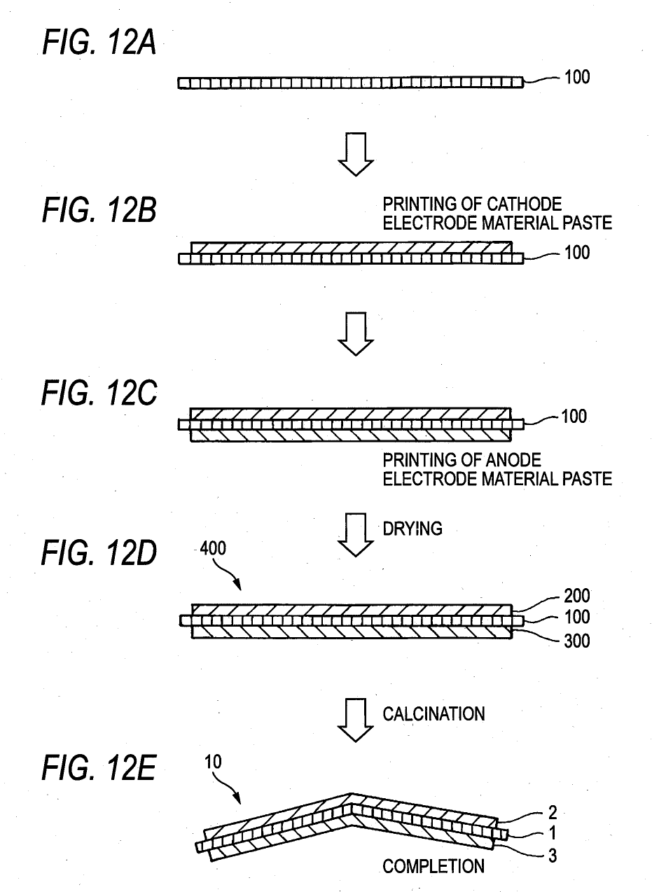

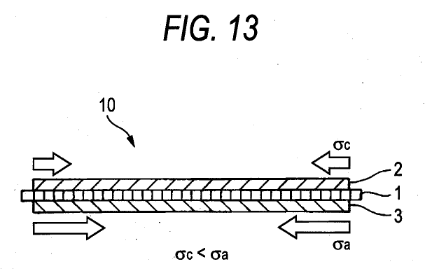

The results are shown in FIG. 10.

It was apparent from FIG. 10 that the values of the maximum electric powers of Examples 8 and 9 in which the oxidation catalyst was added to the anode electrode layer were better than that of Example 12 in which the oxidation catalyst was not added to the anode electrode layer though the same electrode formation material was used. The reason why the maximum electric powers of Examples 8 and 9 improve is probably because generation of soot in the anode electrode layer is suppressed.

Also, a relation between Example 11 and Example 14 and a relation between Example 10 and Example 13 shown in FIG. 10 are similar. Particularly, improvement in power generation characteristics by adding the oxidation catalyst to the anode electrode layer is remarkable in Example 11 using LSM as the electrode formation material.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A solid oxide type fuel cell comprising:
a solid electrolyte substrate;
a cathode electrode layer formed on one surface of said substrate; and
an anode electrode layer formed on the other surface of said substrate,
wherein the cathode electrode layer and the anode electrode layer are formed by the same electrode formation material.

2. A solid oxide type fuel cell as claimed in claim 1, wherein the electrode formation material includes one or plural oxides selected from ferrite, manganate and cobaltate.

3. A solid oxide type fuel cell as claimed in claim 1,
wherein at least one of the cathode electrode layer or the anode electrode layer contains the electrode formation material and a solid electrolyte, and
wherein a concentration of the solid electrolyte included in the cathode electrode layer or the anode electrode layer increases with approach to the solid electrolyte substrate.

4. A solid oxide type fuel cell as claimed in claim 3, wherein the cathode electrode layer or the anode electrode layer has a multilayer structure by layers having different solid electrolyte concentrations.

5. A solid oxide type fuel cell as claimed in claim 1,
wherein at least one of the cathode electrode layer or the anode electrode layer is formed in a porous state, and
wherein a porosity in the cathode electrode layer or the anode electrode layer increases with distance from the solid electrolyte substrate.

6. A solid oxide type fuel cell as claimed in claim 5, wherein the cathode electrode layer or the anode electrode layer has a multilayer structure by layers having different porosities.

7. A solid oxide type fuel cell as claimed in claim 1, wherein one or plural oxidation catalysts selected from rhodium oxide, ruthenium oxide and titanium oxide are added to the anode electrode layer.

8. A solid oxide type fuel cell as claimed in claim 1, wherein said solid oxide type fuel cell is placed in premixed fuel in which a fuel component is mixed with an oxidizing agent component.

9. A solid oxide type fuel cell as claimed in claim 1, wherein the anode electrode layer is exposed to flames by combustion of a fuel component and air is supplied to the cathode electrode layer.

10. A manufacturing method of a solid oxide type fuel cell having a solid electrolyte substrate, a cathode electrode layer formed on one surface of said substrate and an anode electrode layer formed on the other surface of said substrate, said method comprising steps of:
producing a solid electrolyte sheet made of a formation material of the solid electrolyte substrate;
applying electrode material pastes made of electrode formation materials respectively to both surfaces of the solid electrolyte sheet;
drying the electrode material pastes to produce a sheet laminated body in which a cathode electrode material sheet and an anode electrode material sheet are laminated on both surfaces of the solid electrolyte sheet; and
calcining the sheet laminated body.

11. A manufacturing method of a solid oxide type fuel cell having a solid electrolyte substrate, a cathode electrode layer formed on one surface of said substrate and an anode electrode layer formed on the other surface of said substrate, said method comprising steps of:
producing a solid electrolyte sheet made of a formation material of the solid electrolyte substrate;
producing a sheet laminated body by placing a cathode electrode material sheet made of a formation material of the cathode electrode layer on one surface of the solid electrolyte sheet and placing an anode electrode material sheet made of the same electrode formation material as the formation material of the cathode electrode layer on the other surface of the solid electrolyte sheet; and
calcining the sheet laminated body.
